(19) United States
(12) Patent Application Publication
(10) Pub. No.: US 2008/0250465 A1
(43) Pub. Date: Oct. 9, 2008

(54) Method and System for the Efficient Management of Video on Demand Service

(75) Inventors: Young Min Kim, Seoul (KR); Gyung Sueng Yang, Seoul (KR); Young Ick Kim, Gwangju (KR)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: HANAROMEDIA CO., LTD., Seoul (KR)

(21) Appl. No.: 12/088,350

(22) PCT Filed: Oct. 21, 2005
(86) PCT No.: PCT/KR2005/003512

§ 371 Date: Mar. 27, 2008

(30) Foreign Application Priority Data
Sep. 29, 2005 (KR) 10-2005-0091035

(51) Int. Cl. H04N 7/173

(52) U.S. Cl. 725/87

(57) ABSTRACT

The present invention relates to a VOD service operating method and system for providing VOD service through interchange of VOD contents between a VOD server and a set-top box. In accordance with the present invention, a plurality of VOD contents are at least categorized as a first mode and a second mode. The VOD contents included in the first mode store beforehand basic information necessary for selecting the VOD contents in the set-top box by PUSH of the VOD server and provide the stored basic information on a display under the management of the VOD management application when the first mode is activated. Further, the VOD contents included in the second mode transfer a request signal of basic information necessary for selecting the VOD contents from the VOD server to the set-top box according to a user's request. They then display in real time the basic information transferred to the set-top box on a display under the management of the VOD management application. According to the present invention, it becomes possible to reduce the user's waiting time required for selecting the VOD contents and the burden upon the network load so as to provide the VOD service in an efficient manner,

### TECHNICAL FIELD

The present invention generally relates to a method and system for providing a video on demand (VOD) service through interchange of VOD contents between a VOD server and a set-top box, and more particularly to a method and system for reducing a user's waiting time required for selecting the VOD contents and a burden upon the network load so as to provide the VOD service in an efficient manner.

### BACKGROUND ART

Digital broadcasting is rapidly becoming common and standardized. Various technical developments are evolving in a number of areas, e.g., digital signal transmission through a broadcasting network, data multiplexing, video and audio signal processing, digital television display and the like. Compared to analog broadcasting, the digital broadcasting can compress informational data for processing. Further, the digital broadcasting has a high transmission speed and provides a superior quality of audio and video compared to analog broadcasting. Moreover, unlike the conventional analog broadcasting, the digital broadcasting is advantageous since it can efficiently utilize frequency due to digital modulation. Therefore, it can broadcast a variety of information through hundreds of channels, which users can access through televisions.

Among others, the digital broadcasting can implement an interactive television by data broadcasting. With the interactive television, the users can interact with the television, in addition to controlling the channel, volume and video tapes. Thus, the users can perform various operations such as payment, banking, shopping, reservation, games, forum discussion and the like. Moreover, there has recently been an increasing interest in ordering and watching VOD contents through the digital broadcasting, as shown in U.S. Pat. Nos. 4,506,387, 4,890,320, 4,995,078, 5,063,610, 5,206,722 and 5,253,275.

In the above conventional VOD service, however, there is a problem in that it takes a very long time for the user to select the VOD contents. Further, the load upon the network can be extremely burdensome.

### DISCLOSURE

### Technical Problem

In order to solve the above-mentioned problems, the present invention provides a method and system for reducing the user's waiting time required for selecting the VOD contents and the burden upon the network load so as to provide the VOD service in an efficient manner.

### Technical Solution

In accordance with an embodiment of the present invention, there is a provided a method for providing video on demand (VOD) service through interchange of VOD contents between a VOD server, which provides a plurality of VOD contents and basic information necessary for selecting the VOD contents, and a set-top box having a VOD management application that manages the VOD contents transmitted from the VOD server. In the method of the present invention, the plurality of VOD contents are at least categorized as a first mode and a second mode. The VOD contents included in the first mode store beforehand basic information necessary for selecting the VOD contents in the set-top box by PUSH of the VOD server. When the first mode is activated, they provide the stored basic information on a display under the management of the VOD management application. Further, the VOD contents included in the second mode transfer a request signal of basic information necessary for selecting the VOD contents from the VOD server to the set-top box according to a user's request. They then display in real time the basic information transferred to the set-top box on a display under the management of the VOD management application.

In accordance with another embodiment of the present invention, when the VOD management application is activated, the first mode is provided on the display in a default option and a menu bar for selecting the second mode is subordinately provided within the display.

In accordance with yet another embodiment of the present invention, when the VOD management application is activated by the user, an activation menu bar of the first mode and an activation menu bar of the second mode are provided in parallel. The function of the first mode or the second mode is independently performed according to the user's selection.

In accordance with still yet another embodiment of the present invention, the VOD server transfers to the set-top box the basic information necessary for selecting the VOD contents included in the first mode, as well as an initial amount of the VOD contents that are displayed on the display during the time required for buffering, by PUSH of the VOD server.

In accordance with even yet another embodiment of the present invention, the basic information necessary for selecting the VOD contents included in the first mode is transferred to the set-top box via a multi-network. Further, the basic information necessary for selecting the VOD contents included in the second mode is transferred to the set-top box via a uni-network.

In accordance with a further embodiment of the present invention, the basic information of the VOD contents included in the first mode is periodically transferred to the set-top box by PUSH of the VOD server. In addition, the previously stored basic information is updated with the transferred basic information under the management of the VOD management application.

In accordance with yet another embodiment of the present invention, there is provided a VOD service operating system for providing VOD service through interchange of VOD contents between a VOD server, which provides a plurality of VOD contents and basic information necessary for selecting the VOD contents, and a set-top box having a VOD management application that manages the VOD contents transmitted from the VOD server. In the VOD service operating system of the present invention, the VOD server manages the plurality of VOD contents by at least categorizing the VOD contents as a first mode and a second mode. The VOD contents included in the first mode store beforehand basic information necessary for selecting the VOD contents in the set-top box by PUSH of the VOD server. When the first mode is activated, they provide the stored basic information on a display under the management of the VOD management application. Further, the VOD contents included in the second mode transfer basic information necessary for selecting the VOD contents from the VOD server to the set-top box according to a user's request. They then display in real time the basic information transferred to the set-top box on a display under the management of the VOD management application. Preferably, the VOD management application provides a menu bar for selecting the first mode and a menu bar for selecting the second mode in parallel. More preferably, the VOD management application activates and displays the first mode in a default option, and subordinately provides a menu bar for selecting the second mode within the display of the first mode. Further, it is preferred that the basic information necessary for selecting the VOD contents included in the first mode is transferred to the set-top box via a multi-network. Further, the basic information necessary for selecting the VOD contents included in the second mode is transferred to the set-top box via a uni-network.

In accordance with still yet another embodiment of the present invention, the VOD server transfers to the set-top box the basic information necessary for selecting the VOD contents included in the first mode, as well as an initial amount of the VOD contents that are displayed on the display during the time required for buffering, by PUSH of the VOD server.

### ADVANTAGEOUS EFFECTS

The VOD service operating method and system in accordance with the present invention provide the following advantageous effects:

(1) In the present invention, the waiting time of the user can be decreased by transferring beforehand the basic information of the VOD contents, which is frequently requested from the user, to the set-top box. Through the method of the present invention, the user's satisfaction of the VOD service can be enhanced.

(2) The present invention can uniformly provide the basic information of the VOD contents, which are frequently requested from the user, via the multi-network. Therefore, it becomes possible to efficiently transfer the basic information without causing any burden upon the network load.

(3) In the present invention, the storage of the set-top box can store an initial amount of the VOD contents that are displayed during the time required for buffering, as well as the basic information of the VOD contents that are frequently requested by the user. By doing so, the user's waiting time can be reduced during buffering time, thereby enhancing the user's satisfaction of the VOD service.

(4) In the present invention, the plurality of VOD contents are categorized as the first and second modes. When the VOD management application installed in the set-top box is activated by the user, the first mode is provided on the display in a default option. Further, a menu bar for selecting the second mode is subordinately provided within the display. By doing so, the user interface for the VOD service can be immediately provided to the user according to the user's request for the VOD service. Further, the data is transferred to the user only when the second mode is activated, thereby additionally reducing the burden upon the network load.

### DESCRIPTION OF DRAWINGS

FIG. 1 is a block diagram illustrating a VOD service operating system for providing VOD service through interchange of VOD contents between a VOD server and a set-top box in accordance with the present invention.

FIG. 2 shows a preferred example of a user interface that is displayed on a screen by a VOD management application used in the VOD service operating method in accordance with the present invention.

### BEST MODE

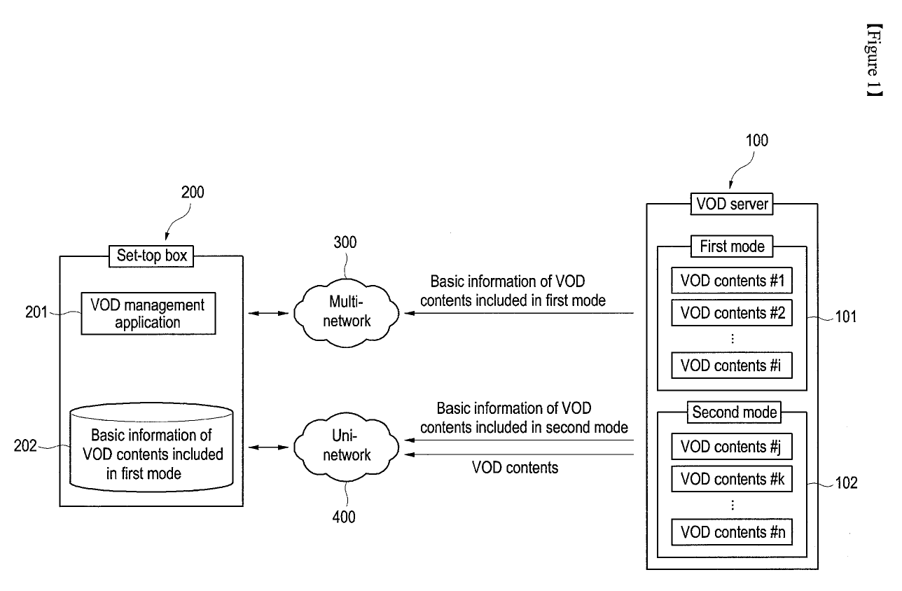

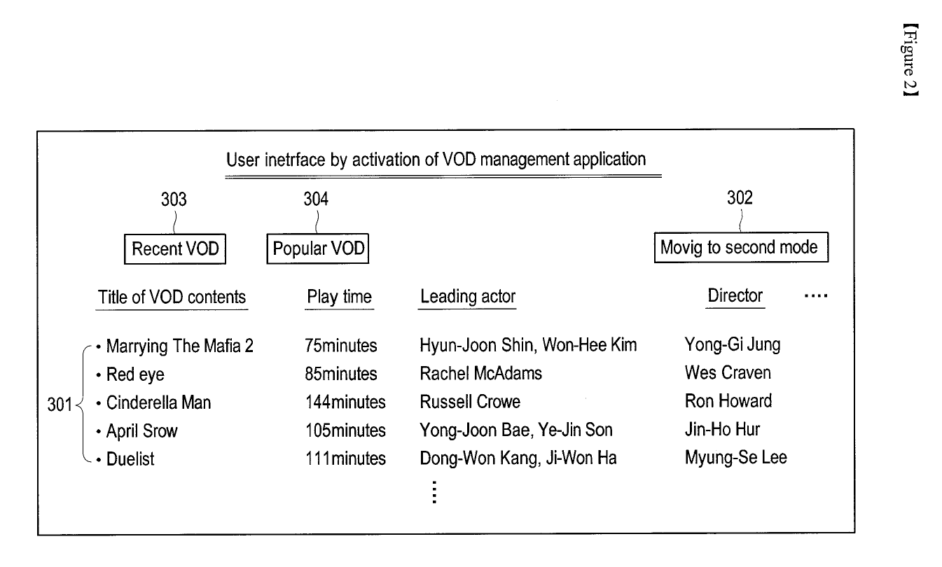

The preferred embodiment of the present invention is described in detail with reference to FIGS. 1 and 2.

FIG. 1 is a block diagram illustrating a VOD service operating system for providing VOD service through interchange of VOD contents between a VOD server and a set-top box in accordance with the present invention. As shown in FIG. 1, the VOD service operating system comprises a VOD server 100 and a set-top box 200, which is connected to the VOD server 100. The VOD server 100 provides the set-top box 200 with a plurality of VOD contents and basic information necessary for selecting the VOD contents. Further, the set-top box 200 displays the basic information necessary for selecting received VOD contents on a screen by using a VOD management application 201 and requests the VOD contents selected by a user from the displayed basic information to the VOD server 100. It then displays the requested VOD contents on the display. This is the same as a conventional VOD service operating method and system.

The first technical feature of the VOD service operating method and system according to the present invention is that the plurality of VOD contents are categorized as the first mode 101 and the second mode 102, wherein said modes 101 and 102 are operated by separate mechanisms. In particular, VOD contents #1-#1 are included in the first mode 101 and VOD contents #j-#n are included in the second mode 102. The basic information necessary for selecting the VOD contents included in the first mode 101 is transferred to the set-top box 200 by PUSH of the VOD server 100. When the first mode 101 is activated, the basic information stored in the set-top box 200 is displayed under the management of the VOD management application 201. Meanwhile, the basic information necessary for selecting the VOD contents included in the second mode 102 is transferred from the VOD server 100 to the set-top box 200 according to the user's request, wherein the transferred basic information is displayed on the display.

The reason why the plurality of VOD contents are categorized as the first and second modes 101 and 102 is that it becomes possible to reduce the network load according to the selection of the VOD contents included in the first mode 101 as well as to effectively reduce the user's waiting time by managing the VOD contents (VOD contents #1-#i in FIG. 1) frequently requested by the user as the first mode 101 and the remaining VOD contents (VOD contents #j-#n in FIG. 1) as the second mode 102. The basic information necessary for selecting the VOD contents included in the first mode 101 and the basic information necessary for selecting the VOD contents included in the second mode 102 are transferred from the VOD server 100 to the set-top box 200 via the network. Preferably, the basic information necessary for selecting the VOD contents included in the first mode is transferred from the VOD server 100 to the set-top box 200 via a multi-network 300. Further, the basic information necessary for selecting the VOD contents included in the second mode is transferred from the VOD server 100 to the set-top box 200 via a uni-network 400. When data is transferred via the multi-network 300, the same data is transferred to all the set-top boxes that are connected to the multi-network 300.

Therefore, the basic information necessary for selecting the VOD contents included in the first mode 101 is transferred to all the set-top boxes 200, which are connected to the multi-network 300. Although only one set-top box 200 is shown in FIG. 1 for simplification, a plurality of set-top boxes 200 can be connected to the VOD server 100 and the basic information necessary for selecting the VOD contents included in the first mode 101 is transferred to all the set-top boxes 200, respectively. When the particular data is transferred via the uni-network 400, the data is selectively transferred to the particular set-top box 200. Therefore, when the VOD server 100 receives the request signal from the particular set-top box 200, the VOD server 100 identifies the identification information of the set-top box from the request signal and transfers information only to the particular set-top box 200 via the uni-network 400.

It is preferable that the basic information necessary for selecting the VOD contents included in the first mode 101 is transferred via the multi-network 300. This is because the transfer via the multi-network 300 can enhance the transfer efficiency of the basic information necessary for selecting the VOD contents included in the first mode 101.

One of the most important things for providing the VOD service is that it takes a very long waiting time to display the VOD contents that are selected by the user. Generally, the waiting time is from 5 seconds to 1 minute, which is the time required for buffering the VOD contents. Statistically, the user is satisfied when the requested VOD contents are displayed within 3 seconds from his/her request. Therefore, if the waiting time is about 10 seconds to 20 seconds, then it can hinder the efficient use of the VOD service. The present invention is directed to solving this problem, wherein an initial amount of the VOD contents included in the first mode 101 that are displayed during the buffering time as well as the basic information necessary for selecting the VOD contents are transferred to the set-top box 200 by PUSH from the VOD server 100. The present invention can reduce the load of the network and the waiting time. The initial amount of the VOD contents that are displayed for the waiting time are transferred via the multi-network 300 with the basic information. Preferably, the initial amount of the VOD contents may cover for 30 seconds to 1 minute.

The VOD contents are categorized as the first and second modes 101 and 102. When the VOD management application 201 of the set-top box 200 is activated by the user, the activation menu bar of the first mode 101 and the activation menu bar of the second mode 102 are provided in parallel on the display. The user can then independently select and perform the function of the first mode 101 or the function of the second mode 102. More preferably, when the VOD management application 201 is activated by the user, the first mode 101 is provided on the display in a default option and the activation menu bar of the second mode 102 is subordinately provided.

FIG. 2 shows a preferred example of a user interface that is displayed on a screen by a VOD management application used in the VOD service operating method in accordance with the present invention. As shown in FIG. 2, when the VOD management application 201 is activated by the user, the first mode 101 is provided on the display in a default option. Therefore, the basic information 301 necessary for selecting the VOD contents included in the first mode 101 is provided on the display. In FIG. 2, the basic information 301 of the VOD contents included in the first mode 101 is classified as the recent VOD 303 and the popular VOD 304, wherein the basic information 301 includes, for example, title 301A, play time 301B, leading actor 301C, director 301 D, etc. As described above, the menu bar 302 for requesting the basic information necessary for selecting the VOD contents included in the second mode 102 is separately provided. The user can request the basic information necessary for selecting the VOD contents included in the second mode 102 by selecting the menu bar 302. The VOD server 100 can then transfer the requested information to the set-top box 200 via the uni-network 400. Further, the set-top box 200 displays the basic information necessary for selecting the VOD contents included in the second mode 102 in real time. In this method, the first mode 101 is preferentially activated without the user's selection between the first mode 101 and the second mode 102, which makes the configuration of the VOD management application simple while facilitating the use of the VOD service.

Further, the basic information of the first mode 101 downloaded beforehand is stored in storage 202 (e.g., a hard disk) within the set-top box 200. To efficiently use the storage 202, the basic information is periodically deleted and updated. This is performed by the VOD management application 201. When the basic information is received to the set-top box 200, the VOD management application 201 can delete all the prior data stored in the storage 202, modify a part of the stored data, or update the stored data with new data. The update of the basic information can be performed weekly, biweekly or monthly.

1. A method for providing video on demand (VOD) service through interchange of VOD contents between a VOD server providing a plurality of VOD contents and basic information necessary for selecting the VOD contents and a set-top box having a VOD management application managing the VOD contents transmitted from the VOD server, wherein:
the plurality of VOD contents are at least categorized as a first mode and a second mode;
the VOD contents included in the first mode store beforehand basic information necessary for selecting the VOD contents in the set-top box by PUSH of the VOD server and provide the stored basic information on a display under management of the VOD management application when the first mode is activated; and
the VOD contents included in the second mode transfer a request signal of basic information necessary for selecting the VOD contents from the VOD server to the set-top box according to a user's request and display in real time the basic information transferred to the set-top box on a display under the management of the VOD management application.

2. The method of claim 1, further comprising providing the first mode on the display in a default option and subordinately providing a menu bar for selecting the second mode within the display when the VOD management application is activated.

3. The method of claim 1, further comprising providing an activation menu bar of the first mode and an activation menu bar of the second mode in parallel and independently performing a function of the first mode or the second mode according to the user's selection when the VOD management application is activated by the user.

4. The method of claim 1, wherein the VOD server transfers to the set-top box the basic information necessary for selecting the VOD contents included in the first mode as well as an initial amount of the VOD contents displayed on the display during time required for buffering by PUSH of the VOD server.

5. The method of claim 1, wherein the basic information necessary for selecting the VOD contents included in the first mode is transferred to the set-top box via a multi-network, and wherein the basic information necessary for selecting the VOD contents included in the second mode is transferred to the set-top box via a uni-network.

6. The method of claim 1, wherein the basic information of the VOD contents included in the first mode is periodically transferred to the set-top box by PUSH of the VOD server, and wherein the previously stored basic information is updated with the transferred basic information under the management of the VOD management application.

7. A VOD service operating system for providing a VOD service through interchange of VOD contents between a VOD server providing a plurality of VOD contents and basic information necessary for selecting the VOD contents and a set-top box having a VOD management application managing the VOD contents transmitted from the VOD server, wherein:
the VOD server manages the plurality of VOD contents by at least categorizing the VOD contents as a first mode and a second mode;
the VOD contents included in the first mode store beforehand basic information necessary for selecting the VOD contents in the set-top box by PUSH of the VOD server and provide the stored basic information on a display under management of the VOD management application when the first mode is activated; and
the VOD contents included in the second mode transfer basic information necessary for selecting the VOD contents from the VOD server to the set-top box according to a user's request and display in real time the basic information transferred to the set-top box on a display under the management of the VOD management application.

8. The VOD service operating system of claim 7, wherein the VOD management application provides a menu bar for selecting the first mode and a menu bar for selecting the second mode in parallel, and wherein the VOD management application performs a function of the first mode and a function of the second mode according to the user's selection.

9. The VOD service operating system of claim 7, wherein the VOD management application activates and displays the first mode in a default option and subordinately provides a menu bar for selecting the second mode within the display of the first mode.

10. The VOD service operating system of claim 7, wherein the VOD server transfers to the set-top box the basic information necessary for selecting the VOD contents included in the first mode as well as an initial amount of the VOD contents displayed on the display during a time required for buffering by PUSH of the VOD server.

11. The VOD service operating system of claim 10, wherein the basic information necessary for selecting the VOD contents included in the first mode is transferred from the VOD server to the set-top box via a multi-network, and wherein the basic information necessary for selecting the VOD contents included in the second mode is transferred from the VOD server to the set-top box via a uni-network.
